(19) United States
(12) Patent Application Publication
(10) Pub. No.: US 2010/0161975 A1
(43) Pub. Date: Jun. 24, 2010

(54) PROCESSING SYSTEM WITH APPLICATION SECURITY AND METHODS FOR USE THEREWITH

(75) Inventors: Paul Ducharme, Scarborough (CA); Lewis Leung, Markham (CA); Xinhui (Philip) Yang, North York (CA)

Correspondence Address: Garlick Harrison & Markison (VIXS), P.O. Box 160727, Austin, TX, 78716-0727, US

(73) Assignee: VIXS Systems, Inc., Toronto (CA)

(21) Appl. No.: 12/339,683

(22) Filed: Dec. 19, 2008

(51) Int. Cl. H04L 9/00

(52) U.S. Cl. 713/164; 726/2

(57) ABSTRACT

A processing system includes an interface for receiving application data at the processing system corresponding to an application, the application data including authentication data. A one-time programmable memory stores at least one application key. A processing module executes an operating system that includes a security routine to authenticate the application data based on the authentication data and the at least one application key. The security routine permits the execution of the application by the processing module when the authentication data is authenticated, and prevents the execution of the application by the processing system when the authentication data is not authenticated.

### CROSS REFERENCE TO RELATED PATENTS

Not applicable

### TECHNICAL FIELD OF THE INVENTION

The present invention relates to security in processing devices.

### DESCRIPTION OF RELATED ART

Signals transmitted between devices can be encrypted to provide secure access. Certain multimedia content, such as music compact disks (CDs), video cassettes and digital video disks (DVDs) are recorded with copy protection signals that are meant to prevent the multimedia content contained on these media from being copied. These copy protection mechanisms can provide challenges to the compression and encoding techniques used when this content is transmitted or stored. In many such circumstances, the copy protection must be disabled for transmission between devices when encryption is used to secure the content from unauthorized copying. In addition, WLAN signals can be encrypted to prevent unauthorized access to the WLAN and to prevent unauthorized access to program content and/or other information that is transmitted over the WLAN. Encrypted signals can also be used for other secure communication and secure access applications.

Processing systems can include operating system programs that allow utilities and application programs to be written for a common computing environment, even when executed on different processing platforms. Operating systems also provide for multitasking that allows the simultaneous execution of multiple applications and utilities, etc. Examples of such operating systems include Microsoft Windows, Mac OS, Linux and Solaris. The flexibility of these operating systems provides several drawbacks. For instance, authors of malicious code such as viruses, worms, Trojan horses and other harmful code have taken advantage of the open nature of operating systems such as Microsoft windows. In response, Microsoft has introduced a system for applying MS root certificates to validate device drivers. While a positive step, additional work is needed in this area to provider greater protections.

Further limitations and disadvantages of conventional and traditional approaches will become apparent to one of ordinary skill in the art through comparison of such systems with the present invention.

### BRIEF DESCRIPTION OF THE SEVERAL VIEWS OF THE DRAWINGS

FIG. 1 presents a pictorial representation of example devices 11-16 that can include a processing system 100 in accordance with an embodiment of the present invention.

FIG. 2 presents a block diagram representation of a processing system 100 in accordance with an embodiment of the present invention.

FIG. 3 presents a block diagram representation of a one time programmable memory in accordance with a further embodiment of the present invention.

FIG. 4 presents a block diagram representation of a video processing system 100′ in accordance with a further embodiment of the present invention.

FIG. 5 presents a block diagram representation of a video encoding system 200 in accordance with an embodiment of the present invention.

FIG. 6 presents a block diagram representation of a video decoding system 202 in accordance with an embodiment of the present invention.

FIG. 7 presents a block diagram representation of a video transcoding system 204 in accordance with an embodiment of the present invention.

FIG. 8 presents a block diagram representation of a video distribution system 175 in accordance with an embodiment of the present invention.

FIG. 9 presents a block diagram representation of a video storage system 179 in accordance with an embodiment of the present invention.

FIG. 10 presents a flowchart representation of a method in accordance with an embodiment of the present invention.

FIG. 11 presents a flowchart representation of a method in accordance with an embodiment of the present invention.

### DETAILED DESCRIPTION OF THE INVENTION INCLUDING THE PRESENTLY PREFERRED EMBODIMENTS

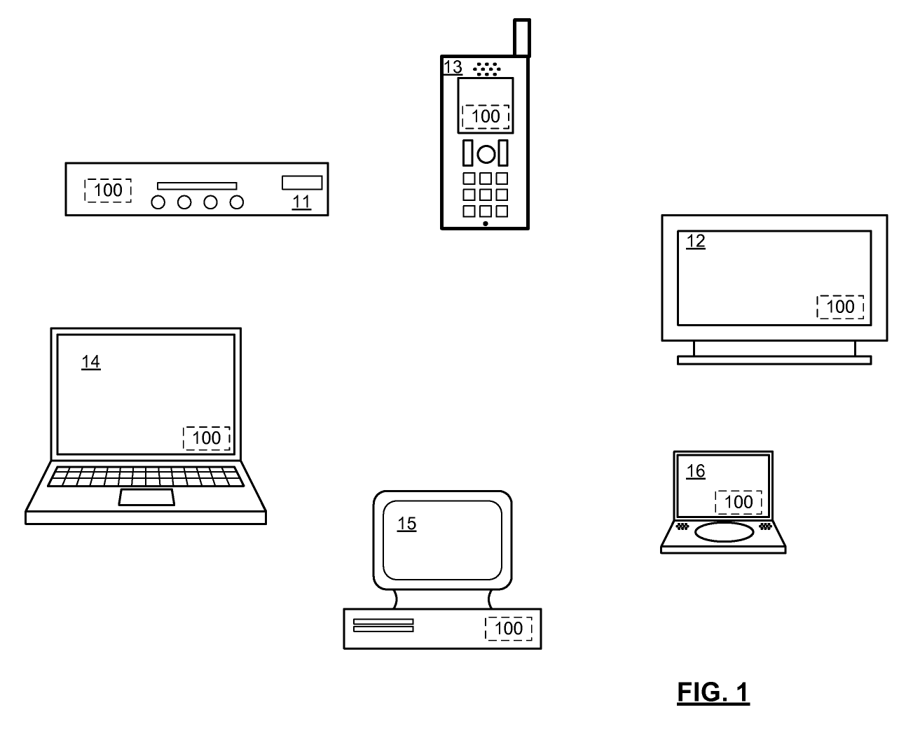

FIG. 1 presents a pictorial representation of example devices 11-16 that can include a processing system 100 in accordance with an embodiment of the present invention. In particular, these example devices include digital video recorder/set top box 11, television or monitor 12, wireless telephony device 13, computers 14 and 15, personal video player 16, or other devices that include a processing system 100.

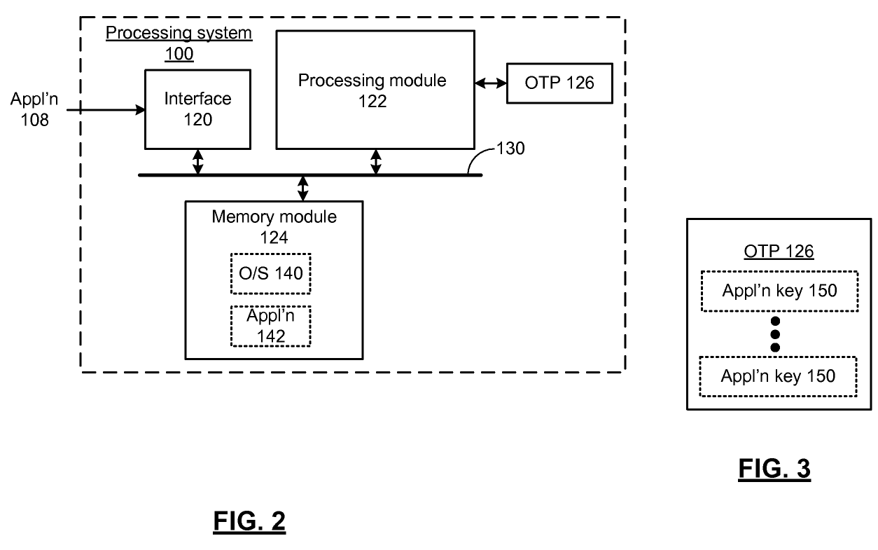

Processing system 100 runs a security routine that authenticates new applications. When the processing system's operating system is requested to load and run an application, the security routine checks authentication data appended to the application such as a password, encryption key, digital signature or other authentication data and verifies that the application is permitted to run. The operating system only runs the application if it has been authenticated to the device. In this fashion, the processing system 100 can help prevent hackers from running rogue applications, such as applications with viruses by, for instance, only running applications with authentication data that indicates that they have been signed by a trusted authority. Further, the security routine can be used as a copy protection measure. For instance, the application itself can be encrypted, and can only be decrypted and run by the operating system, if the operating system has the proper application key 114. New applications can be coded for a particular processing system 100 or a particular class of similar processing systems 100. In this fashion, the new applications will run only on devices that include the appropriate application key. Processing system 100 will be described in greater detail in conjunction with FIGS. 2-11, including several optional functions and features.

While processing module 100 is shown as being integrated in each of the devices 11-16, in an alternative embodiment of the present invention, processing module 100 can be coupled to one or more of these host devices via a host interface. In particular, processing module 100 can take on any one of a number of form factors such as a PC card, memory card, personal computer memory card international association (PCMCIA) card, universal serial bus (USB) dongle or other device that is coupleable to one or more host devices via an Ethernet connection, a memory card interface, USB connection, Firewire (IEEE 1394) connection, small computer system interface (SCSI), PCMCIA interface, or other interface either standard or proprietary or that is incorporated into the device 11-16.

FIG. 2 presents a block diagram representation of a processing system 100 in accordance with an embodiment of the present invention. In particular, processing system 100 includes interface 120, processing module 122, memory mode 124, one-time programmable memory 126, and bus 130. Memory module 124 stores an operating system 140 such as a Linux, Mac OS, MS Windows, Solaris or other operating system that has been modified to include a security routine. In addition, memory module 124 stores one or more applications 142 to be executed by processing system 100 via the operating system 142, as well as program files and other data files, system data, registers, buffers, drivers, utilities and other system programs.

In an embodiment of the present invention, the memory module 124 further includes a boot loader that is executed by the processing module 122 to boot up the processing system 100. The operating system 142 can itself be scrambled and signed or otherwise encrypted. When the operating system 142 is loaded during boot up, the boot loader can descramble or otherwise authenticate the operating system 142 prior to execution to prevent a hacked version of the operating system from being run).

Interface 120 can be a general purpose input/output device, a serial or parallel data interface or other interface. One-time programmable memory 126 can be implemented via a programmable read only memory (PROM), a field programmable read only memory (FPROM) or other one-time programmable memory that can be programmed to store one or more application keys 114.

The processing module 122 can be implemented using a single processing device or a plurality of processing devices. Such a processing device may be a microprocessor, co-processors, a micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions that are stored in a memory, such as memory module 124. Memory module 124 may be a single memory device or a plurality of memory devices. Such a memory device can include a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry. While a particular bus architecture is shown, alternative architectures using direct connectivity between one or more modules and/or additional buses can likewise be implemented in accordance with the present invention. In an embodiment of the present invention, processing system 100 is implemented via a system on a chip integrated circuit.

In operation, interface 120 receives application data 108 corresponding to a new application to be run by processing system 100. As discussed above, the application data 108 can be stored in memory module 124. The application data 108 includes authentication data such as a digital certificate, password, code phrase, code data or other authentication data that indicates either the source of the application, that indicates the application can be trusted by the processing system 100 or otherwise has been encoded specifically for operation by one or more processing systems 100. The processing module 122 executes an operating system 140 that includes the security routine.

As discussed in conjunction with FIG. 1, the security routine attempts to authenticate the application data 108 based on the authentication data and one of the application keys 114. When the authentication data is authenticated, the security routine permits the execution of the application by the operating system and processing module 122. When the authentication data is not authenticated, the security routine prevents the execution of the application by the operating system and processing system 100.

The application keys 114 can be encryption keys or other data that can be used by the security routine to certify, decrypt, recognize or otherwise authenticate valid authentication data included in the application data 108. For example, a plurality of processing systems 100 can be provided with a general application key 114, such as a private key that is securely stored in processing system 100. Applications meant to run on these processing modules are encoded with complementary authentication data, such as a public key obtained via certification from a trusted authority. When the application data 108 that corresponds to these applications is received, the authentication data can be recognized via the security routine and authenticated to the operating system 140.

In another example, the application data 108 can itself include an encryption key that can be used by the operating system 142 to decrypt or otherwise descramble content associated with the application, decrypt or otherwise descramble other content or other applications received by the processing system 100. In this fashion, the application keys 114 can be used to decrypt other keys used in the operation of the processing system 100. These other keys can be static keys that can be used indefinitely or dynamic keys that expire after some predetermined time or upon the occurrence of some event. For instance, some keys included in application data 108 may expire after a period of time as in scenarios where a user is allowed to view content or use an application for a only fixed period of time. Other such keys may expire when the system is turned on/off or reset or may be one time use keys which can not be used a second time.

In another example, a processing system 100 can be provided with a particular application key 114, that is specific to a particular application. When presented with the application data 108 that corresponds to this particular application, the security routine only allows that application to run (or is only capable of running that application) on the processing systems 100 that have been preprogrammed with the particular application key 114 required to run the application.

In a further example, a processing system 100 can be provided with a particular application key 114, such as a device specific application key 114 that is specific to that particular processing system 100. When application data 108 is prepared for that particular processing system 100, it is encoded with authentication data from a trusted authority that is complementary to the device specific application key 114 of processing system 100. When presented with the application data 108 the security routine for that processing system 100 allows that application to run.

It should be noted that processing system 100 can operate in conjunction with one or more modes of operation discussed above. In this fashion, the one-time programmable memory 126 can store a plurality of application keys 114, including one or more general application keys, application specific processing keys and a processing system specific processing key. When presented with a new application to load and run, the security routine can process the corresponding authentication data via each of the application keys 114 in succession to see if the application data can be authenticated via any one of the application keys 114. The security routine can continue until the new application is authenticated with one of the application keys 114 or all of the application keys 114 have been tried.

FIG. 3 presents a block diagram representation of a one time programmable memory in accordance with a further embodiment of the present invention. In particular, one time programmable memory 126 is shown with a plurality of application keys 150, such as application keys 114. In the manufacturing process, the one-time programmable memory 126 is programmed in the fabrication facility or otherwise to store the application keys 150. As discussed in conjunction with FIG. 2, the one-time programmable memory 126 can store a plurality of application keys 150, that include one or more general application keys, application specific processing keys and/or a processing system specific processing key. In this fashion, the processing system 100 can be programmed to include the application keys 150 that are needed based on the device that will host the processing system 100 and optionally the particular applications that are intended to run on that particular device or class of devices.

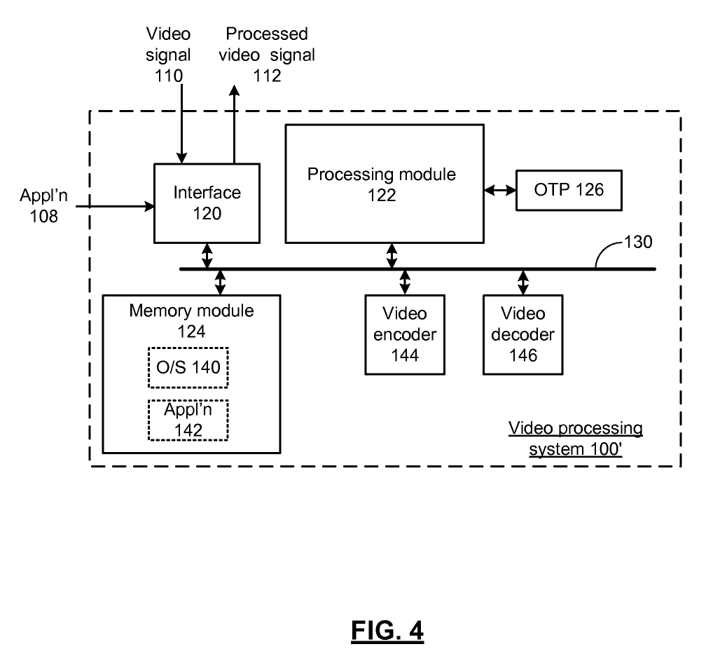

FIG. 4 presents a block diagram representation of a video processing system 100′ in accordance with a further embodiment of the present invention. In particular, video processing system 100′ includes the elements of processing system 100 that are referred to by common reference numerals. In addition, the video processing system includes video encoder 144 and video decoder 146 that can be implemented via one or more routines running on processing module 122 or via application specific circuits such as a video encoding engine and video decoding engine.

In operation, applications 142 include one or more video processing applications executed by the processing module 122. Interface 120 further receives a video signal 110 and outputs a processed video signal 112 generated by the video processing application based on an encoding of the video signal 110, a decoding of the video signal 110 and/or a transcoding of the video signal 110. While referred to as video signals, video signal 110 and processed video signal 112 can each include an associated audio component. As used herein, transcoding can include transrating, transcrypting, and/or transcaling the video signal 110 to generate processed video signal 112 in addition to transcoding the video signal 110 from one encoded video format into another encoded video format (MPEG1,2,4 to H.264, etc.) to form processed video signal 112. Transcoding can further include transcoding the audio portion of video signal 110 to a different sample rate, encoding standard or other digital format, stereo to mono, etc.

Signal interface 120 can receive video signal 110 via a wireless receiver via a WLAN, Bluetooth connection, infrared connection, wireless telephony receiver or other wireless data connection, or a wired modem or other network adaptors that uses a wired receiver or other device to receive the decrypted signal from a LAN, the Internet, cable network, telephone network or other network or from another device. Signal interface 120 can also receive video signal 110 in accordance with an Ethernet protocol, a memory card protocol, USB protocol, Firewire (IEEE 1394) protocol, SCSI protocol, PCMCIA protocol, or other protocol either standard or proprietary.

Video signal 110 and processed video signal 112 can each be analog or digital video signals in any of a number of video formats with or without an associated audio component. Such analog video signal can include formats such as National Television Systems Committee (NTSC), Phase Alternating Line (PAL) or Sequentiel Couleur Avec Memoire (SECAM). Such digital video formats can include formats such as H.264, MPEG-4 Part 10 Advanced Video Coding (AVC) or other digital format such as a Moving Picture Experts Group (MPEG) format (such as MPEG1, MPEG2 or MPEG4), Quicktime format, Real Media format, Windows Media Video (WMV), Audio Video Interleave (AVI), high definition media interface (HDMI) or another digital video format, either standard or proprietary.

Video signal 110 and/or processed video signal 112 can be generated in association with a set-top box, television receiver, personal computer, cable television receiver, satellite broadcast receiver, broadband modem, 3G transceiver, a broadcast satellite system, internet protocol (IP) TV system, the Internet, a digital video disc player, a digital video recorder, or other video device. In an embodiment of the present invention, the video signals 110 and or 112 can include a broadcast video signal, such as a television signal, high definition television signal, enhanced high definition television signal or other broadcast video signal that has been transmitted over a wireless medium, either directly or through one or more satellites or other relay stations or through a cable network, optical network or other transmission network. In addition, the video signal 110 and/or processed video signal 112 can be generated from a stored video file, played back from a recording medium such as a magnetic tape, magnetic disk or optical disk, and can include a streaming video signal that is transmitted over a public or private network such as a local area network, wide area network, metropolitan area network or the Internet. In operation, video processing module 100′ is coupled to the receiving module 100 to encode, transrate, transcrypt, transcale and/or otherwise transcode one or more of the video signals 110 to form processed video signal 112.

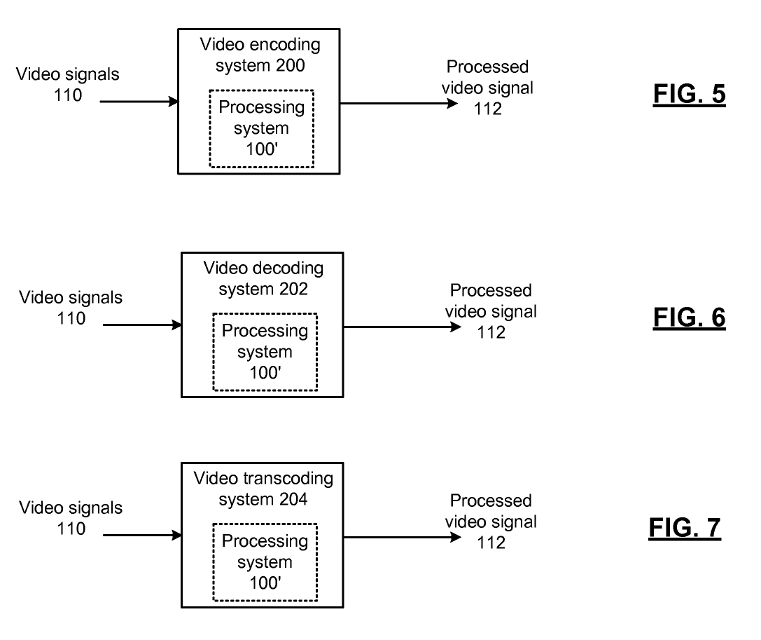

FIG. 5 presents a block diagram representation of a video encoding system 200 in accordance with an embodiment of the present invention. In particular, video encoding system 200, such as video processing system 100′, operates in accordance with many of the functions and features of the H.264, MPEG-4 Part 10 Advanced Video Coding (AVC), or other digital format such as a Moving Picture Experts Group (MPEG) format (such as MPEG1, MPEG2 or MPEG4), VC-1 (SMPTE standard 421M), Quicktime format, Real Media format, Windows Media Video (WMV), Audio Video Interleave (AVI), high definition media interface (HDMI) or another digital video format, either standard or proprietary or other video format, to encode video input signals 110 to form processed video signal 112.

FIG. 6 presents a block diagram representation of a video decoding system 202 in accordance with an embodiment of the present invention. In particular, video decoding system 202, such as video processing system 100′, operates in accordance with many of the functions and features of the H.264, MPEG-4 Part 10 Advanced Video Coding (AVC), or other digital format such as a Moving Picture Experts Group (MPEG) format (such as MPEG1, MPEG2 or MPEG4), VC-1 (SMPTE standard 421M), Quicktime format, Real Media format, Windows Media Video (WMV), Audio Video Interleave (AVI), high definition media interface (HDMI) or another digital video format, either standard or proprietary or other video format, to decode video input signals 110 to form processed video signal 112.

FIG. 7 presents a block diagram representation of a video transcoding system 204 in accordance with an embodiment of the present invention. In particular, video transcoding system 204, such as video processing system 100′, operates in accordance with many of the functions and features of the H.264, MPEG-4 Part 10 Advanced Video Coding (AVC), or other digital format such as a Moving Picture Experts Group (MPEG) format (such as MPEG1, MPEG2 or MPEG4), VC-1 (SMPTE standard 421M), Quicktime format, Real Media format, Windows Media Video (WMV), Audio Video Interleave (AVI), high definition media interface (HDMI) or another digital video format, either standard or proprietary or other video format, to transcode video input signals 110 to form processed video signal 112.

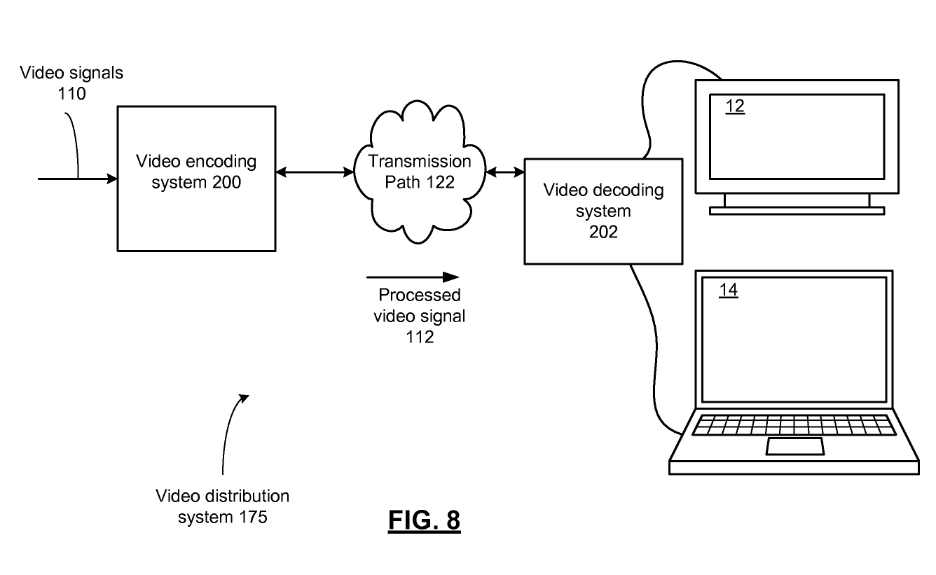

FIG. 8 presents a block diagram representation of a video distribution system 175 in accordance with an embodiment of the present invention. In particular, processed video signal 112 is transmitted via a transmission path 122 to a video decoder 202. Video decoder 202, in turn can operate to decode the processed video signal 112 for display on a display device such as television 10, computer 20 or other display device.

The transmission path 122 can include a wireless path that operates in accordance with a wireless local area network protocol such as an 802.11 protocol, a WIMAX protocol, a Bluetooth protocol, etc. Further, the transmission path can include a wired path that operates in accordance with a wired protocol such as a USB protocol, high-definition multimedia interface (HDMI) protocol an Ethernet protocol or other high speed protocol.

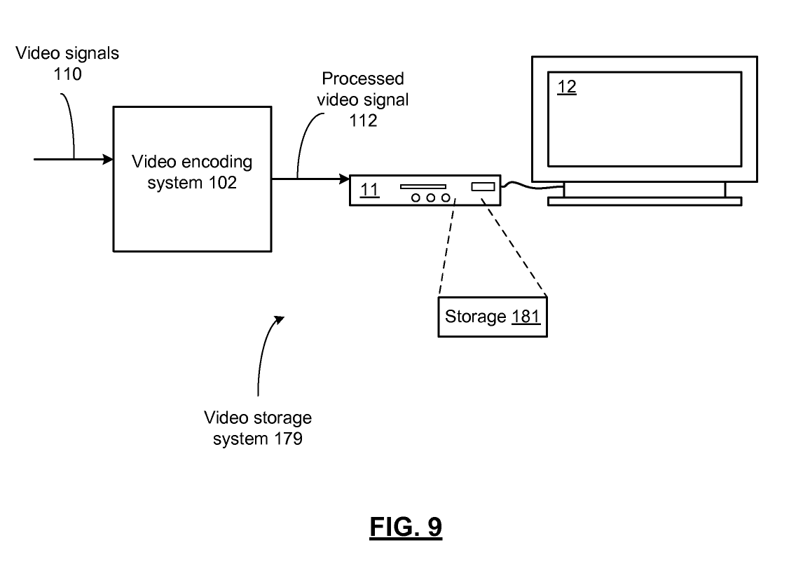

FIG. 9 presents a block diagram representation of a video storage system 179 in accordance with an embodiment of the present invention. In particular, device 11 is a set top box with built-in digital video recorder functionality, a stand alone digital video recorder, a DVD recorder/player or other device that stores the processed video signal 112 in storage 181 for display on video display device such as television 12. Storage 181 can include a hard disk drive optical disk drive or other disk drive, read-only memory, random access memory, volatile memory, non-volatile memory, static memory, dynamic memory, flash memory, cache memory, and/or any device that stores digital information. Storage 181 can be integrated in the device 11 or coupled to the device 11 via a network, wireline coupling or other connection.

While video encoder 200 is shown as a separate device, it can further be incorporated into device 11. While these particular devices are illustrated, video storage system 179 can include a hard drive, flash memory device, computer, DVD burner, or any other device that is capable of generating, storing, decoding and/or displaying a video stream 220 in accordance with the methods and systems described in conjunction with the features and functions of the present invention as described herein.

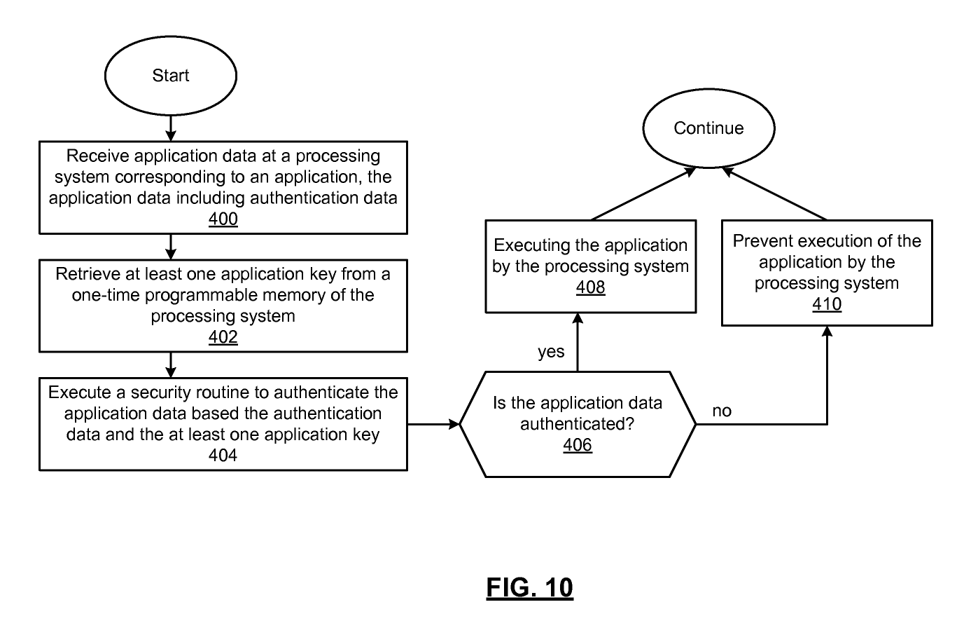

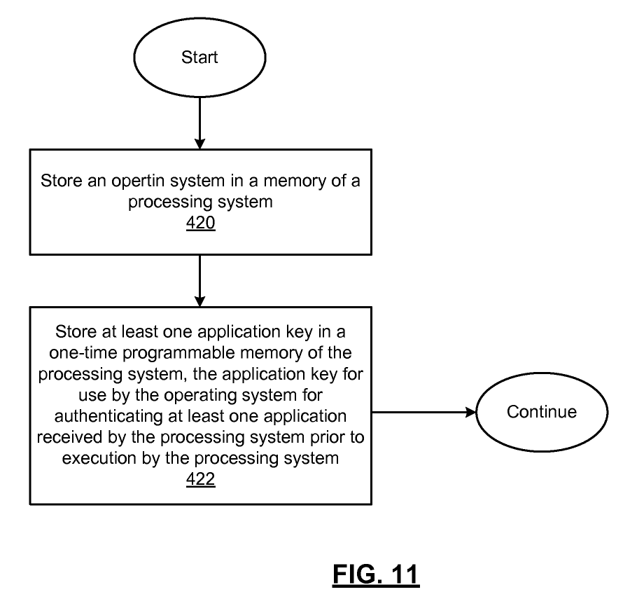

FIG. 10 presents a flowchart representation of a method in accordance with an embodiment of the present invention. In particular a method is presented for use in conjunction with one or more functions and features described in conjunction with FIGS. 1-8. In step 400, application data is received at the processing system corresponding to an application, the application data including authentication data. In step 402, at least one application key is retrieved from a one-time programmable memory of the processing system. In step 404, a security routine is executed to authenticate the application data based on the authentication data and the at least one application key. In step 406, the method determines whether or not the application data was authenticated. In step 408, the application is executed by the processing system when the authentication data is authenticated. In step 410, the execution of the application by the processing system is prevented, when the authentication data is not authenticated.

In an embodiment of the present invention, the application keys can include an application key that is particular to the processing system. The application keys can also include an application key that is particular to the application. Step 404 can include authenticating the application data when the authentication data is authenticated to one of the plurality of application keys. Step 404 can also include attempting to authenticate the application data based on selected ones of the plurality of application keys. The operating system can be a Linux, Mac OS, MS Windows or Solaris operating system that has been modified to include the security routine

FIG. 11 presents a flowchart representation of a method in accordance with an embodiment of the present invention In particular a method is presented for use in conjunction with one ore more functions and features described in conjunction with FIGS. 1-9. In step 420, an operating system is stored in a memory of the processing system during manufacturing and/or set-up of the processing system. In step 422, at least one application key is stored in a one-time programmable memory of the processing system, the application key for use in by the operating system for authenticating at least one application received by the processing system prior to execution by the processing system.

In an embodiment of the present invention, one or more application keys can be stored. The application key or keys can include an application key that is particular to the processing system and an application key that is particular to the application.

While particular combinations of various functions and features of the present invention have been expressly described herein, other combinations of these features and functions are possible that are not limited by the particular examples disclosed herein are expressly incorporated within the scope of the present invention.

As one of ordinary skill in the art will further appreciate, the term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “coupled”.

As the term module is used in the description of the various embodiments of the present invention, a module includes a functional block that is implemented in hardware, software, and/or firmware that performs one or more functions such as the processing of an input signal to produce an output signal. As used herein, a module may contain submodules that themselves are modules.

Thus, there has been described herein an apparatus and method, as well as several embodiments including a preferred embodiment, for implementing a processing system and video processing system along with an application security routine for use therewith and with other processing systems. Various embodiments of the present invention herein-described have features that distinguish the present invention from the prior art.

It will be apparent to those skilled in the art that the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. A processing system comprising:
an interface for receiving application data at the processing system corresponding to an application, the application data including authentication data;
a one-time programmable memory that stores at least one application key;
a processing module, coupled to the interface and the one-time programmable memory, that executes an operating system that includes a security routine to authenticate the application data based on the authentication data and the at least one application key, wherein the security routine permits the execution of the application by the processing module when the authentication data is authenticated, and that prevents the execution of the application by the processing system when the authentication data is not authenticated.

2. The processing system of claim 1 wherein the at least one application key includes a first application key that is particular to the processing system.

3. The processing system of claim 1 wherein the at least one application key includes a first application key that is particular to the application.

4. The processing system of claim 1 wherein the at least one application key includes a plurality of application keys and wherein executing the security routine includes authenticating the application data when the authentication data is authenticated to one of the plurality of application keys.

5. The processing system of claim 4 wherein executing the security routine includes attempting to authenticate the application data based on selected ones of the plurality of application keys.

6. The processing system of claim 1 wherein the operating system is a Linux operating system.

7. The processing system of claim 1 wherein the application is a video processing application;
wherein, when the video processing application is executed by the processing module, the interface further receives a video signal and outputs a processed video signal generated by the video processing application based on at least one of:
an encoding of the video signal;
a decoding of the video signal; and
a transcoding of the video signal.

8. The processing system of claim 7 further comprising at least of:
an encoding engine, coupled to the processing module, for encoding the video signal; and
an decoding engine, coupled to the processing module, for decoding of the video signal.

9. The processing system of claim 1 wherein the application data includes at least one of: a static encryption key, and a dynamic encryption key.

10. A method for use in an operating system executed by a processing system, the method comprising:
receiving application data at the processing system corresponding to an application, the application data including authentication data;
retrieving at least one application key from a one-time programmable memory of the processing system;
executing a security routine to authenticate the application data based on the authentication data and the at least one application key;
executing the application by the processing system when the authentication data is authenticated; and
preventing the execution of the application by the processing system when the authentication data is not authenticated.

11. The method of claim 10 wherein the at least one application key includes a plurality of application keys and wherein executing the security routine includes authenticating the application data when the authentication data is authenticated to one of the plurality of application keys.

12. The method of claim 13 wherein executing the security routine includes attempting to authenticate the application data based on selected ones of the plurality of application keys.

13. A method for use in manufacturing a processing system, the method comprising:
storing an operating system in a memory of the processing system; and
storing at least one application key in a one-time programmable memory of the processing system, the application key for use in by the operating system for authenticating at least one application received by the processing system prior to execution by the processing system.

14. The method of claim 13 wherein the at least one application key includes a first application key that is particular to the processing system.

15. The method of claim 13 wherein the at least one application key includes a first application key that is particular to the application.
